(19) United States
(12) Patent Application Publication
(10) Pub. No.: US 2009/0271948 A1
(43) Pub. Date: Nov. 5, 2009

(54) HINGE WITH LESS NOISE

(76) Inventor: Ting-Hsien WANG, Shulin City (TW)

Correspondence Address: Hershkovitz & Associates, LLC, 2845 Duke Street, Alexandria, VA, 22314, US

(21) Appl. No.: 12/499,796

(22) Filed: Jul. 8, 2009

Related U.S. Application Data
(63) Continuation-in-part of application No. 11/362,825, filed on Feb. 28, 2006.

(51) Int. Cl. E05D 11/08

(52) U.S. Cl. 16/340; 16/337

(57) ABSTRACT

A hinge with less noise pivotally connects to a cover and a base of an electrical appliance and has a stationary-positioning element, a rotating-positioning element and a noise-eliminated spacer. The stationary-positioning element is mounted securely in the base and has at least one positioning protrusion. The rotating-positioning element is mounted securely in the cover and has at least one positioning detent corresponding to the positioning protrusion when the cover is closed. The noise-eliminated spacer is attached to the rotating-positioning element to let the stationary-positioning element and the rotating-positioning element in constant contact, which results in friction between the stationary-positioning element and the rotating-positioning element being uniform. The noise-eliminated spacer is made by metal stamping process to well form the size of the through hole for tightly engage the deformed portion of the shaft to eliminate noise.

### RELATED PATENT APPLICATION

This is a Continuation-In-Part Application of U.S. application Ser. No. 11/362,825, filed on Feb. 28, 2006; the disclosure of which is expressly incorporated by reference herein in its entirety.

### BACKGROUND OF THE INVENTION

1. Field of the Invention

The present invention relates to a hinge, especially to a hinge mounted in an electrical appliance and making less noise.

2. Description of the Prior Arts

With reference to FIGS. 9 and 10, a conventional hinge comprises a shaft (100), a rotating bracket (101), a first washer (102), a second washer (103), a spring (104) and a fastening sleeve (105). The shaft (100) has a deformed portion (1001). The rotating bracket (101) is mounted rotatably around the shaft (100). The first washer (102) is mounted rotatably around the shaft (100) and has multiple positioning protrusions. The second washer (103) is mounted securely around the shaft (100) adjacent to the first washer (102) and has a hole (1031) and multiple positioning detents. The hole (1031) is configured to match the deformed portion (1001) of the shaft (100) so that the first washer (102) is rotated simultaneously with the shaft (100). The positioning detents selectively engage the positioning protrusions to provide positioning function. The spring (104) is mounted around the shaft (100) and abuts the second washer (103) to generate frictions between the first and second washers (102, 103) while the second washer (103) is rotated relative to the first washer (102). The fastening sleeve (105) is mounted around the shaft (100) to hold the above elements.

The conventional hinge is mounted between a cover and a base of a portable electronic device such as cell phones, notebook computers. The friction between the first and second washers (102, 103) holds the cover at desired visual angle. The first and second washers (102, 103) must be strong enough to bear long term abrasion. Therefore, the first and second washers (102, 103) are made by Metal Injection Molding process (MIM process) to be hard enough.

However, the washers (102, 103) made by MIM process have well hardness but have bad precision. This is because the washers (102, 103) shrink after sintering in MIM process. Therefore it is difficult to precisely control the size of the washers (102, 103). If the size of the hole (1031) of the second washer (103) is too large, a gap is formed between the hole (1031) of the second washer (103) and the deformed portion (1001) of the shaft (100). When the shaft (100) is rotated, the gap induces bump to cause noises. Therefore, the second washer (103) that is too large must not be used. The manufacturing cost is thus enhanced.

To overcome the shortcomings, the present invention provides a hinge with less noise to mitigate or obviate the aforementioned problems.

### SUMMARY OF THE INVENTION

The main objective of the present invention is to provide a hinge with less noise. The hinge with less noise pivotally connects to a cover and a base of an electrical appliance and has a stationary-positioning element, a rotating-positioning element and a noise-eliminated spacer. The stationary-positioning element is mounted securely in the base and has at least one positioning protrusion. The rotating-positioning element is mounted securely in the cover and has at least one positioning detent corresponding to the positioning protrusion when the cover is closed. The noise-eliminated spacer is attached to the rotating-positioning element to let the stationary-positioning element and the rotating-positioning element in constant contact, which results in friction between the stationary-positioning element and the rotating-positioning element being uniform. The noise-eliminated spacer is made by metal stamping process to well form the size of the through hole for tightly engage the deformed portion of the shaft to eliminate noise.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge with less noise in accordance with the present invention;

FIG. 2 is an exploded perspective view of the hinge in FIG. 1;

FIG. 3 is another exploded perspective view of the hinge in FIG. 1;

FIG. 4 is a perspective view of a notebook computer with the hinge in FIG. 1;

FIG. 5 is an operational enlarged side view in partial section of the hinge in FIG. 1;

FIG. 6 is another operational enlarged side view in partial section of the hinge in FIG. 1;

FIG. 7 is an exploded perspective view of another embodiment of a hinge in accordance with the present invention;

FIG. 8 is another exploded perspective view of the hinge in FIG. 7;

FIG. 8A is an enlarged exploded perspective view of a rotating-positioning element and a noise-eliminated spacer of the hinge in FIG. 7;

FIG. 9 is an exploded perspective view of a conventional hinge in accordance with the prior art; and

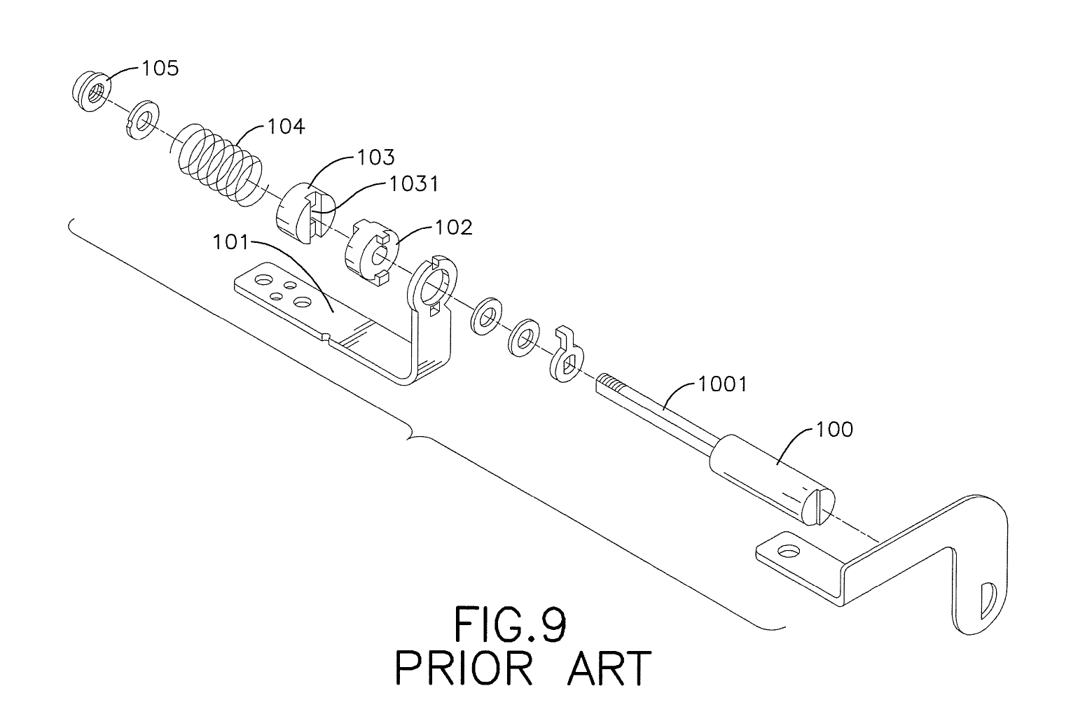

FIG. 10 is an enlarged side view of the conventional hinge in FIG. 9.

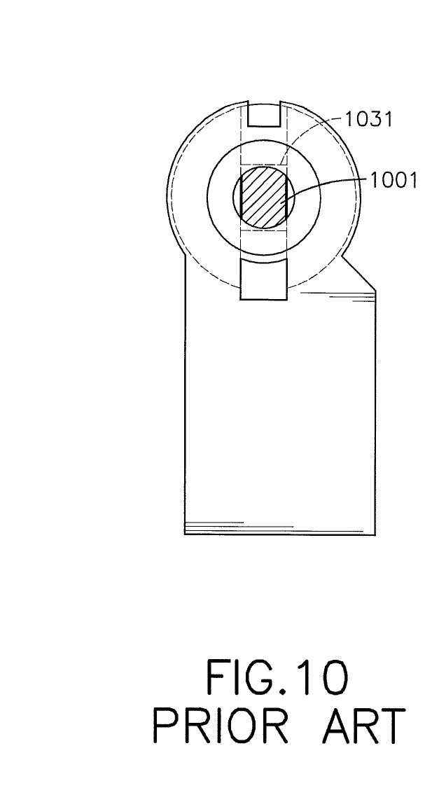

### DETAILED DESCRIPTION OF THE PREFERRED EMBODIMENTS

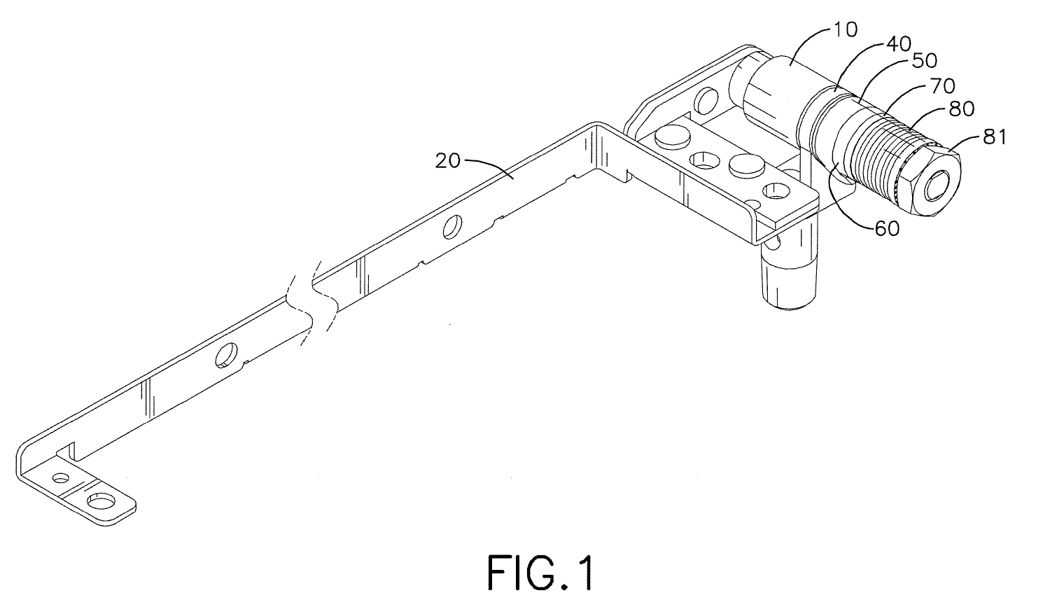

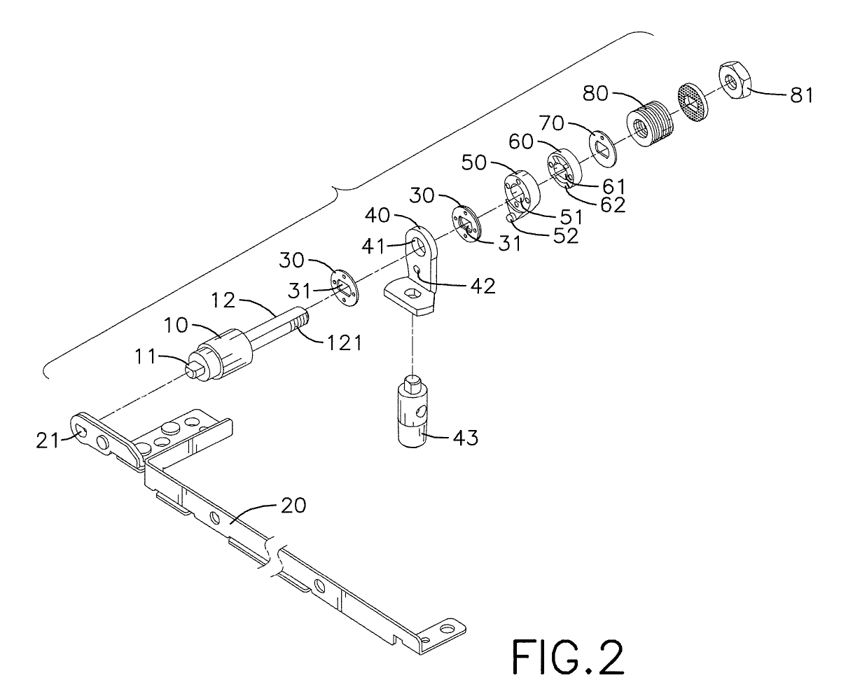

With reference to FIGS. 1 and 2, a hinge with less noise in accordance with the present invention comprises a shaft (10), a rotating bracket (20), a washer assembly (30), a stationary bracket (40), a stationary-positioning element (50), a rotating-positioning element (60), a noise-eliminated spacer (70), a biasing member (80) and a fastener (81).

The shaft (10) has a proximal end, a distal end, an optional fastening protrusion (11), an optional deformed portion (12) and an optional thread (121). The fastening protrusion (11) is formed axially on the proximal end and is non-circular. The deformed portion (12) is formed axially on the distal end and is non-circular. The thread (121) is formed on the deformed portion (12).

The rotating bracket (20) is mounted securely on the shaft (10) and may have a through hole (21). The through hole (21) is formed through the rotating bracket (20), is non-circular and engages the fastening protrusion (11) of the shaft (10) to mount the rotating bracket (20) securely on the shaft (10).

The washer assembly (30) is mounted securely on the shaft (10) and has at least one washer. Each washer is mounted securely on the shaft (10) and may have through hole (31). The through hole (31) is formed through the washer, is non-circular and engages the deformed portion (12) to mount the rotating bracket (20) securely on the shaft (10).

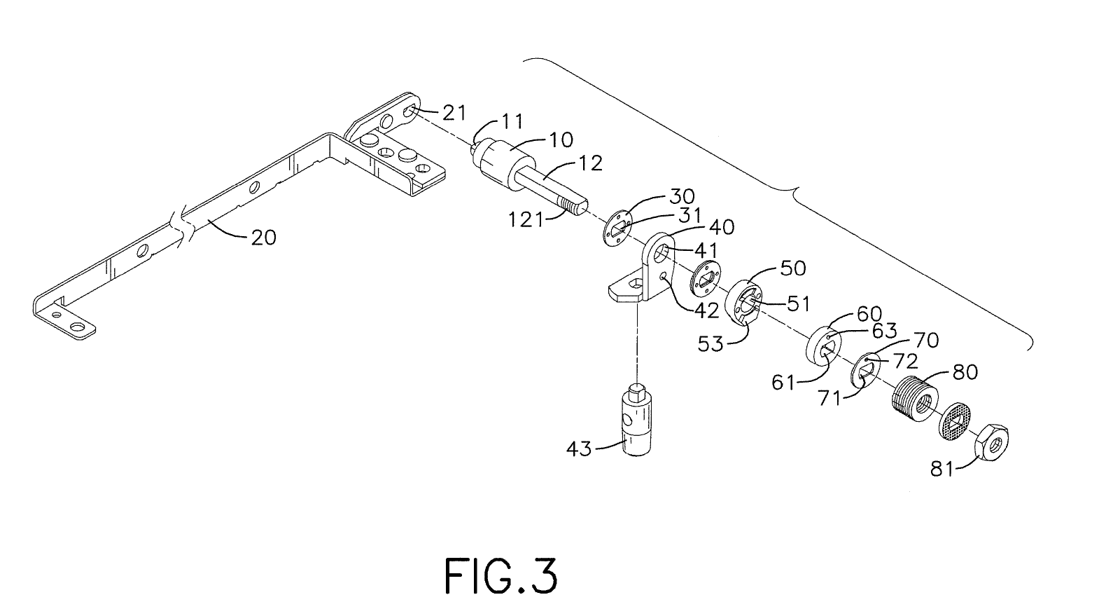

With further reference to FIG. 3, the stationary bracket (40) is mounted pivotally around the shaft (10), may be L-shaped and may have a transverse wing, a longitudinal wing, a circular hole (41), a fastening hole (42) and a pin (43). The transverse wing is mounted around the shaft (10). The circular hole (41) is formed through the transverse wing and is mounted around the deformed portion (12) of the shaft (10). The fastening hole (42) is formed through the transverse wing. The pin (43) is mounted securely on the longitudinal wing.

The stationary-positioning element (50) is mounted pivotally around the shaft (10), is attached to the stationary bracket (40), has a first side, a second side and at least one positioning protrusion (53) and may have a circular hole (51) and a fastening protrusion (52). The at least one positioning protrusion (53) is formed on the second side of the stationary-positioning element (50). The circular hole (51) is formed through the stationary-positioning element (50) and is mounted around the deformed portion (12) of the shaft (10). The fastening protrusion (52) is formed on the first side of the stationary-positioning element (50) and extends through the fastening hole (42) of the stationary bracket (40) to attach the stationary-positioning element (50) to the stationary bracket (40).

The rotating-positioning element (60) is slidably mounted around the shaft (10), is mounted adjacent to the stationary-positioning element (50), has a first side, a second side and at least one positioning detent (62) and may have a through hole (61) an a fastening protrusion (63). The at least one detent (62) is formed on the first side of the rotating-positioning element (60) and corresponds to and selectively engages the at least one positioning protrusion of the stationary-positioning element (50). The through hole (61) is formed through the rotating-positioning element (60) is non-circular and engages the deformed portion (12) of the shaft (10) to mount the rotating-positioning element (60) securely around the shaft (10). The fastening protrusion (63) is formed on the second side of the rotating-positioning element (60).

The noise-eliminated spacer (70) is slidably mounted around the shaft (10), is mounted adjacent to and is attached to the rotating-positioning element (60) and may have a through hole (71) and a fastening hole (72). The through hole (71) is formed through the noise-eliminated spacer (70), is non-circular and engages the deformed portion (12) of the shaft (10) to mount the noise-eliminated spacer (70) on the shaft (10). The fastening hole (72) is formed through the noise-eliminated spacer (70) and engages the fastening protrusion (63) of the rotating-positioning element (60) to attach the noise-eliminated spacer (70) to the rotating-positioning element (60). The noise-eliminated spacer (70) is made by metal stamping process to precisely form the size of the through hole (71) so that the through hole (71) tightly engages the deformed portion (12) of the shaft (10).

The biasing member (80) is mounted around the shaft (10). The fastener (81) is mounted on the shaft (10) and may be a nut to screw on the thread (121) of the shaft (10).

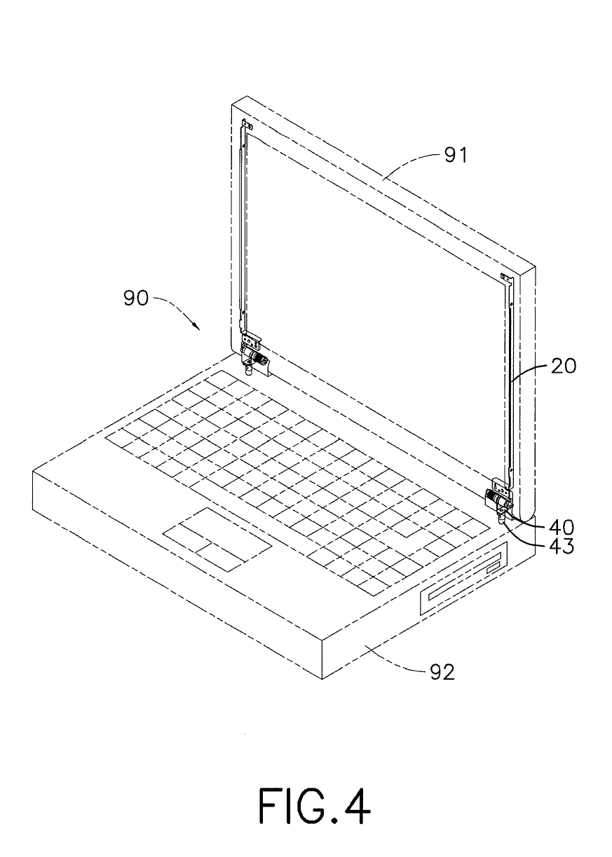

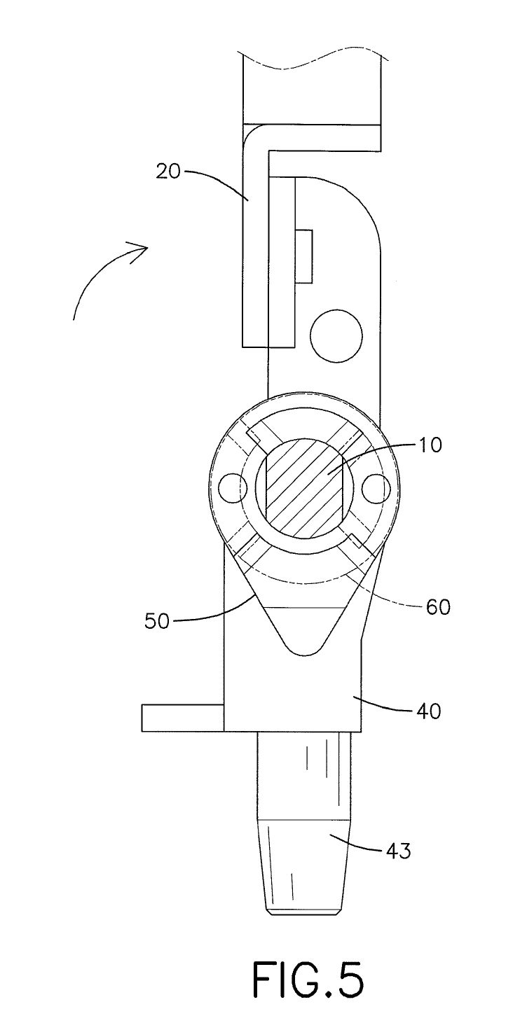

With further reference to FIGS. 4 and 5, an electrical appliance (90) comprises a cover (91) and a base (92). The rotating bracket (20) is attached to the cover (91). The pin (43) of the stationary bracket (40) is attached to the base (92). Because the rotating bracket (20) and the rotating-positioning element (60) are mounted on the shaft (10), the rotating-positioning element (60) is rotated with the shaft (10) when the cover (91) is rotated in relative to the base (92).

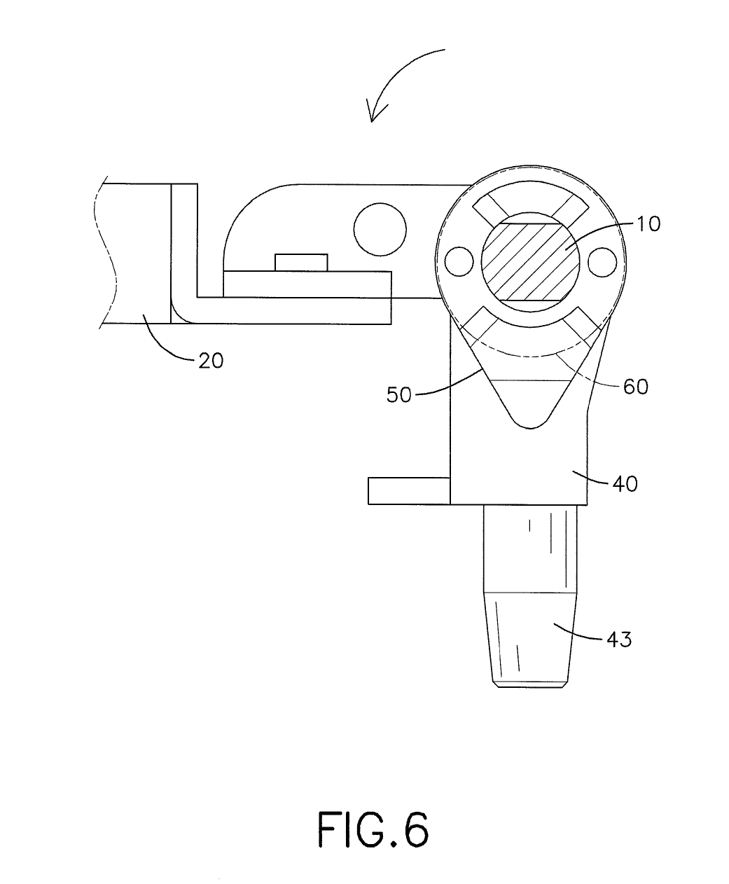

With further reference to FIG. 6, the cover (91) is closed. The positioning protrusion (53) engages the positioning detent (62) to keep the cover (91) from bumping against the base (92).

As mentioned above, the rotating-positioning element (60) is manufactured by MIM process, so it is difficult to precisely control the size of the through hole (61) and thus noise generated because the shaft (10) hits the surface of the through hole (61) when the rotating-positioning element (60) is brought to rotate relative to the stationary-positioning element (50). In order to eliminate the noise, the noise-eliminated spacer (70) is accurately manufactured, to form the needed size of the through hole (71) to perfectly match the size of the deformed portion (12) of the shaft (10), and is fixed to the rotating-positioning element (60). Since the noise-eliminated spacer (70) tightly engages the deformed portion (12) of the shaft (10), the shaft (10) does not bump the inside wall of the through hole (61) of the rotating-positioning element (60) even the size of the through hole (61) of the rotating-positioning element (60) is too large. Therefore, the hinge in accordance with the present invention preserves the rotating-positioning element (60) made by MIM process with well hardness and less precision and add a noise-eliminated spacer (70) made by metal stamping process with well precision to keep the shaft (10) without bumping into the inside wall of the through hole (61) of the rotating-positioning element (60). Thus, the hinge as described makes less noise. Furthermore, the noise-eliminated spacer (70) effectively let the stationary-positioning element (50) and the rotating-positioning element (60) in constant contact, which results in friction between the stationary-positioning element (50) and the rotating-positioning element (60) being uniform.

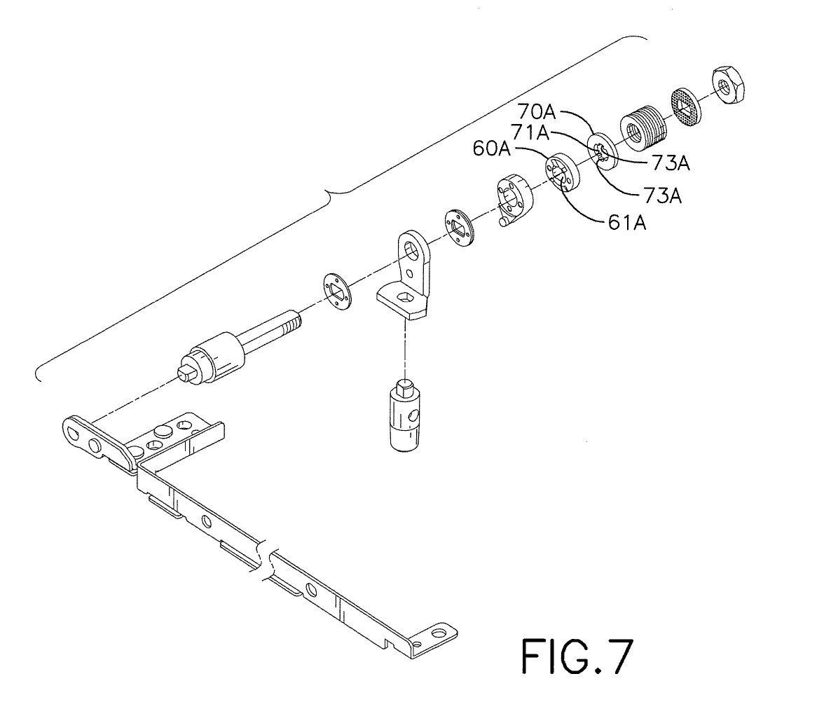

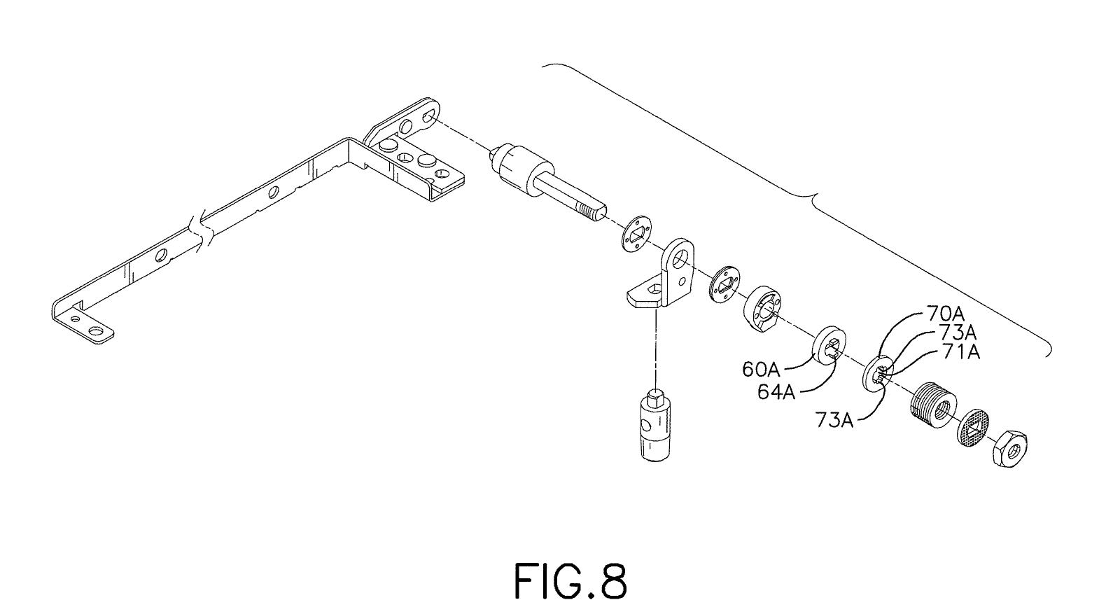

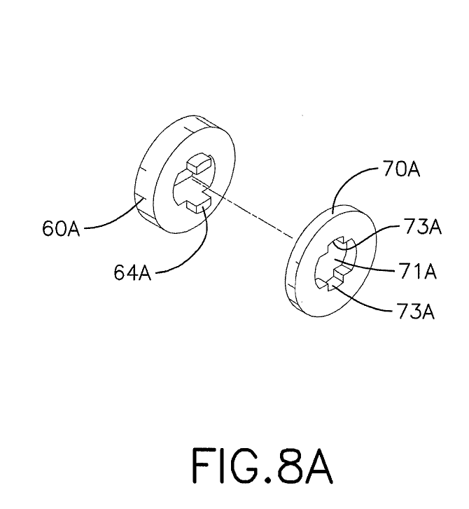

With further reference to FIGS. 7, 8 and 8A, in another embodiment, the rotating-positioning element (60A) has two tongues (64A) oppositely protruding from the second side and being adjacent to the through hole (61A). The noise-eliminated spacer (70A) has two receiving recesses (73A) formed oppositely beside the through hole (71A) and engaging the tongues (64A) to securely attach the noise-eliminated spacer (70A) to the rotating-positioning element (60A). Through this design, parts of the inside wall of the through hole (71A) are to be oppositely engaged with the two tongues (64A) to tightly fix each other, and the rest parts of the inside wall of the through hole (71A) are to be accurately engaged with the shaft (10); accordingly, noise generated when the hinge is rotated is eliminated.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a shaft having a proximal end, a distal end and a non-circular deformed portion formed axially on the distal end of the shaft;
a rotating bracket mounted securely around the shaft;
a washer assembly mounted securely around the shaft and having at least one washer mounted securely on the shaft;
a stationary bracket mounted pivotally around the shaft;
a stationary-positioning element mounted pivotally around the shaft, attached to the stationary bracket and having
a first side;
a second side; and
at least one positioning protrusion formed on the second side of the stationary-positioning element;
a rotating-positioning element mounted slidably around the shaft, mounted adjacent to the stationary-positioning element and having
a first side;
a second side;
a non-circular through hole formed through the rotating-positioning element and engaging the deformed portion of the shaft;
at least one positioning detent formed on the first side of the rotating-positioning element and corresponding to and selectively engaging the at least one positioning protrusion of the stationary-positioning element; and
two tongues oppositely protruding from the second side of the rotating-positioning element and being adjacent to the through hole;
a noise-eliminated spacer slidably mounted around the shaft, mounted adjacent to and attached to the rotating-positioning element and having
a non-circular through hole formed through the noise-eliminated spacer and engaging the deformed portion of the shaft; and
two receiving recesses formed oppositely beside the through hole of the noise-eliminated spacer and engaging the tongues of the rotating-positioning element
a biasing member mounted around the shaft; and
a fastener mounted securely around the shaft;
wherein the noise-eliminated spacer is made by stamping process to allow the through hole of the noise-eliminated spacer tightly engaging the deformed portion of the shaft to eliminate noise.

2. The hinge as claimed in claim 1, wherein
the shaft has a non-circular fastening protrusion formed axially on the proximal end of the shaft; and
the rotating bracket has a non-circular through hole formed through the rotating bracket and engaging the fastening protrusion of the shaft.

3. The hinge as claimed in claim 2, wherein
the stationary bracket has
a transverse wing mounted around the shaft;
a longitudinal wing; and
a fastening hole formed through the transverse wing; and
the stationary-positioning element has a fastening protrusion formed on
the first side of the stationary-positioning element and extending through the fastening hole of the stationary bracket.

4. The hinge as claimed in claim 3, wherein the stationary bracket has a pin mounted securely on the longitudinal wing of the stationary bracket.

5. The hinge as claimed in claim 4, wherein
each washer of the washer assembly has a non-circular through hole formed through the washer and engaging the deformed portion of the shaft;
the stationary bracket has a circular hole formed through the transverse wing and mounted around the deformed portion of the shaft; and
the stationary-positioning element has a circular hole formed through the stationary-positioning element and mounted around the deformed portion of the shaft.

6. The hinge as claimed in claim 5, wherein
the shaft has a thread formed on the deformed portion; and
the fastener is a nut to screw on the thread of the shaft.
